(19) United States
(12) Patent Application Publication
(10) Pub. No.: US 2022/0186071 A1
(43) Pub. Date: Jun. 16, 2022

(54) HEAT-SENSITIVE AQUEOUS POLYURETHANE DISPERSION AND METHOD FOR PREPARING THE SAME

(71) Applicant: Dow Global Technologies LLC, Midland, MI (US)

(72) Inventors: Yunlong Guo, Shanghai (CN); Xiangyang Tai, Shanghai (CN); Yanli Feng, Shanghai (CN); Yi Zhang, Shanghai (CN)

(21) Appl. No.: 17/603,103

(22) PCT Filed: Jun. 4, 2019
(86) PCT No.: PCT/CN2019/089962

§ 371 Date: Oct. 12, 2021

(51) Int. Cl. C09D 175/08; C08G 18/08; C08G 18/76; C08G 18/12; C08G 18/48; C08K 5/42; C08K 5/17; D06N 3/14; D06N 3/00

(52) U.S. Cl. CPC C09D 175/08; C08G 18/0866; C08G 18/7671; C08G 18/12; C08G 18/4841; D06N 2211/28; C08K 5/42; C08K 5/17; D06N 3/14; D06N 3/0059; C08G 18/4829

(57) ABSTRACT

A heat sensitive aqueous polyurethane dispersion is provided. The heat sensitive aqueous polyurethane dispersion comprises an aqueous polyurethane dispersion; a cationic surfactant; and an anionic surfactant. A method for preparing the heat-sensitive aqueous polyurethane dispersion and a synthetic leather article comprising a film derived from the heat-sensitive aqueous polyurethane dispersion and a coating comprising the heat-sensitive aqueous polyurethane dispersion are also provided.

### FIELD OF THE INVENTION

The present disclosure relates to a heat-sensitive aqueous polyurethane dispersion and a method for preparing the same, a synthetic leather article comprising a film derived from the heat-sensitive aqueous polyurethane dispersion and a coating comprising the heat-sensitive aqueous polyurethane dispersion.

### INTRODUCTION

Aqueous polyurethane dispersion (PUD) is a green alternative to PU solution in DMF. It uses water to disperse polyurethane into small particles and stabilizes the particles by internal or externally added surfactants. In some applications, PUD needs to be de-emulsified firstly. Typically, a large amount of coagulant should be used, which leads to plenty of waste water.

Heat-sensitive PUD, also called thermally coagulable PUD, has been explored to address the above issue. This kind of PUD has a long shelf life (e.g. over several days, weeks, or even months) under low temperature, such as room temperature, but will quickly coagulate once exposed to high temperature, such as 40-130° C. It has been described to impregnate textiles or fleeces, make filaments, make thin layer articles and make more efficiently dried coatings. However, nearly all the heat-sensitive character is derived from the low cloud points of nonionic surfactants (e.g. polyethylene oxide chains), which will lose its hydrophilicity above a certain temperature and thus de-emulsify the dispersion. Nevertheless, a product made from this kind of dispersion often displays a low moisture resistance due to the large amount of hydrophilic polyethylene oxide chains needed to make a stable aqueous dispersion. Therefore, there still remains a constant demand for a new heat-sensitive aqueous polyurethane dispersion which overcomes the above deficiencies.

After persistent exploration, we have surprisingly found that a small molecular cationic surfactant can change a typical externally emulsified PUD with an anionic surfactant, which originally does not have heat-sensitivity property, into a thermally coagulable PUD. Similarly, a small molecular anionic surfactant can change a typical externally emulsified PUD with a cationic surfactant, which originally does not have heat-sensitivity property, into a thermally coagulable PUD. Based on these finding, the present disclosure was completed.

### SUMMARY OF THE INVENTION

The present disclosure provides a heat-sensitive aqueous polyurethane dispersion and a method for preparing the same, a synthetic leather article comprising a film derived from the heat-sensitive aqueous polyurethane dispersion and a coating comprising the heat-sensitive aqueous polyurethane dispersion.

In a first aspect of the present disclosure, the present disclosure provides a heat-sensitive aqueous polyurethane dispersion comprising:

(a) an aqueous polyurethane dispersion;

(b) at least one anionic surfactant; and

(c) at least one cationic surfactant.

In a second aspect of the present disclosure, the present disclosure provides a method for preparing a heat-sensitive aqueous polyurethane dispersion, comprising (i) providing (a) an aqueous polyurethane dispersion; (b) at least one anionic surfactant and (c) at least one cationic surfactant; and (ii) mixing them together.

In a third aspect of the present disclosure, the present disclosure provides a method for preparing a heat-sensitive aqueous polyurethane dispersion, comprising (i) providing (a) an aqueous polyurethane dispersion externally emulsified by (b) at least one anionic surfactant, (ii) providing (c) at least one cationic surfactant; and (iii) mixing them together.

In a fourth aspect of the present disclosure, the present disclosure provides a method for preparing a heat-sensitive aqueous polyurethane dispersion, comprising (i) providing (a) an aqueous polyurethane dispersion externally emulsified by (c) at least one cationic surfactant, (ii) providing (b) at least one anionic surfactant; and (iii) mixing them together.

In a fifth aspect of the present disclosure, the present disclosure provides a synthetic leather article, comprising a film derived from the heat-sensitive aqueous polyurethane dispersion.

In a sixth aspect of the present disclosure, the present disclosure provides a coating comprising the heat-sensitive aqueous polyurethane dispersion.

It is to be understood that both the foregoing general description and the following detailed description are exemplary and explanatory only and are not restrictive of the invention, as claimed.

### BRIEF DESCRIPTION OF THE DRAWINGS

FIG. 1 shows the photographs of Control Example 2, 3, 4 and 5 after the PUDs were mixed with DTAB at room temperature.

FIG. 2 shows the photographs of Control Example 1, Inventive Example 7, 8, 9 and 10 after the PUDs were mixed with DTAB and treated under 80° C. for 5 minutes.

FIG. 3 shows the photographs of Inventive Example 8 and 13 after the PUDs were mixed with DTAB and treated under 80° C. for 5 minutes.

### DETAILED DESCRIPTION OF THE INVENTION

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

The articles “a”, “an” and “the” are used to refer to one or more than one (i.e., to at least one) of the grammatical object of the article.

As disclosed herein, the term “composition”, “formulation” or “mixture” refers to a physical blend of different components, which is obtained by mixing simply different components by a physical means.

As disclosed herein, “and/or” means “and, or as an alternative”. All ranges include endpoints unless otherwise indicated.

As disclosed herein, “an internally stabilized polyurethane dispersion” is one that is stabilized through the incorporation of ionically or nonionically hydrophilic pendant groups within the polyurethane of the particles dispersed in the liquid medium. Examples of nonionic internally stabilized polyurethane dispersions are described by U.S. Pat. Nos. 3,905,929 and 3,920,598. Ionic internally stabilized polyurethane dispersions are well known and are described in col. 5, lines 4-68 and col. 6, lines 1 and 2 of U.S. Pat. No. 6,231,926: (Potentially) ionic monomers (a3) are described at length for example in Ullmanns Encyklopädie der technischen Chemie, 4th edition, volume 19, pages 311-313 and for example in DE-A 1 495 745. (Potentially) cationic monomers (a3) of particular industrial importance are especially monomers having tertiary amino groups, for example: tris(hydroxyalkyl)amines, N,N′-bis(hydroxyalkyl)-alkylamines, N-hydroxyalkyldialkylamines, tris(aminoalkyl)amines, N,N′-bis(aminoalkyl)alkylamines, N-aminoalkyldialkylamines, wherein the alkyl radicals and alkanediyl units of these tertiary amines independently have from 1 to 6 carbon atoms. These tertiary amines are converted into the ammonium salts either with acids, preferably strong mineral acids such as phosphoric acid, sulfuric acid, hydrohalic acids or strong organic acids or by reaction with suitable quaternizing agents such as C1- to C6-alkyl halides or benzyl halides, for example bromides or chlorides. Suitable monomers having (potentially) anionic groups are customarily aliphatic, cycloaliphatic, araliphatic or aromatic carboxylic acids and sulfonic acids which bear at least one alcoholic hydroxyl group or at least one primary or secondary amino group. Preference is given to dihydroxyalkylcarboxylic acids, especially having from 3 to 10 carbon atoms, as also described in U.S. Pat. No. 3,412,054. Preference is given especially to compounds of the general formula:

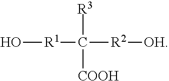

where R¹ and R² are each a C₁- to C₄-alkanediyl unit and R³ is a C₁- to C₄-alkyl unit, and especially to dimethylolpropionic acid (DMPA). Also suitable are corresponding dihydroxysulfonic acids and dihydroxyphosphonic acids such as 2,3-dihydroxypropanephosphonic acid. It is also possible to use dihydroxy compounds having a molecular weight from more than 500 to 10,000 g/mol and having at least 2 carboxylate groups, which are known from DE-A 3 911 827. As monomers (a3) having isocyanate reactive amino groups there may be used aminocarboxylic acids such as lysine, β-alanine and the adducts of aliphatic diprimary diamines with α,β-unsaturated carboxylic or sulfonic acids mentioned in DE-A-2034479. Such compounds conform for example to the formula (a3.1)

H₂N—R⁴—NH—R⁵—X (a3.1)

where —R⁴ and R⁵ are independently C₁- to C₆-alkanediyl, preferably ethylene and X is COOH or SO₃H. Particularly preferred compounds of the formula (a3.1) are N-(2-aminoethyl)-2-aminoethanecarboxylic acid and also N-(2-aminoethyl)-2-aminoethanesulfonic acid and also the corresponding alkali metal salts, among which sodium is particularly preferred as counterion. Particular preference is further given to the adducts of the abovementioned aliphatic diprimary diamines with 2-acrylamido-2-methylpropanesulfonic acid as described for example in D 1 954 090. Typically, dihydroxyalkylcarboxylic acids such as described by U.S. Pat. No. 3,412,054 are used to make anionic internally stabilized polyurethane dispersions. A common monomer used to make an anionic internally stabilized polyurethane dispersion is dimethylolpropionic acid (DMPA).

As disclosed herein, “an externally stabilized polyurethane dispersion” is one that substantially fails to have an ionic or nonionic hydrophilic pendant groups and thus requires the addition of a surfactant to stabilize the polyurethane dispersion. Examples of externally stabilized polyurethane dispersions are described in U.S. Pat. Nos. 2,968,575; 5,539,021; 5,688,842 and 5,959,027.

The Aqueous Polyurethane Dispersion

The aqueous polyurethane dispersion is one in which the dispersion is substantially free of organic solvents. Organic solvent means organic compounds typically used as solvents. Generally, organic solvents display a heightened flammability and vapor pressure (i.e., greater than about 0.1 mm of Hg). Substantially free of organic solvents means that the dispersion was made without any intentional addition of organic solvents to make the prepolymer or the dispersion. That is not to say that some amount of solvent may be present due to unintentional sources such as contamination from cleaning the reactor. Generally, the aqueous dispersion has at most about 1 percent by weight of the total weight of the dispersion. Preferably, the aqueous dispersion has at most about 2000 parts per million by weight (ppm), more preferably at most about 1000 ppm, even more preferably at most about 500 ppm and most preferably at most a trace amount of a solvent. In a preferred embodiment, no organic solvent is used, and the aqueous dispersion has no detectable organic solvent present (i.e., “essentially free” of an organic solvent).

The polyurethane dispersion (a) is not an internally stabilized polyurethane dispersion, that is to say, the polyurethane does not have ionically or nonionically hydrophilic pendant groups within the polyurethane.

To reiterate, the polyurethane dispersion (a) comprises a nonionizable polyurethane dispersion and an optional external stabilizing surfactant, such as (b) at least one anionic surfactant or (c) at least one cationic surfactant as described hereafter in the present disclosure. A nonionizable polyurethane is one that does not contain a hydrophilic ionizable group. A hydrophilic ionizable group is one that is readily ionized in water such as DMPA. Examples of other ionizable groups include anionic groups such as carboxylic acids, sulfonic acids and alkali metal salts thereof. Examples of cationic groups include ammonium salts by reaction of a tertiary amine and strong mineral acids such as phosphoric acid, sulfuric acid, hydrohalic acids or strong organic acids or by reaction with suitable quartinizing agents such as C1-C6 alkyl halides or benzyl halides (e.g., Br or Cl).

The nonionizable polyurethane dispersion may be mixed with other dispersions so long as the dispersion is easily and quickly coagulated as described below. The nonionizable dispersion may even be mixed with an internally stabilized polyurethane dispersion so long as the overall dispersion is easily coagulated, under high temperature. Other polymer dispersions or emulsions that may be useful when mixed with the nonionizable polyurethane dispersion include polymers such as polyacrylates, polyisoprene, polyolefins, polyvinyl alcohol, nitrile rubber, natural rubber and co-polymers of styrene and butadiene. Usually, the nonionizable polyurethane is above 30% volume fraction of the dried film if other polymer dispersion exists in the impregnation slurry. Most preferably, the nonionizable dispersion is used alone (i.e., not mixed with any other polymeric dispersion or emulsion).

Generally, the nonionizable polyurethane is prepared by reacting a polyurethane/urea/thiourea prepolymer with a chain-extending reagent in an aqueous medium and optionally in the presence of a stabilizing amount of an external surfactant, such as (b) at least one anionic surfactant or (c) at least one cationic surfactant as described hereafter in the present disclosure. The polyurethane/urea/thiourea prepolymer can be prepared by any suitable method such as those well known in the art. The prepolymer is advantageously prepared by contacting a high molecular weight organic compound having at least two active hydrogen atoms with sufficient polyisocyanate, and under such conditions to ensure that the prepolymer is terminated with at least two isocyanate groups.

The polyisocyanate is preferably an organic diisocyanate, and may be aromatic, aliphatic, or cycloaliphatic, or a combination thereof. Representative examples of diisocyanates suitable for the preparation of the prepolymer include those disclosed in U.S. Pat. No. 3,294,724, column 1, lines 55 to 72, and column 2, lines 1 to 9, incorporated herein by reference, as well as U.S. Pat. No. 3,410,817, column 2, lines 62 to 72, and column 3, lines 1 to 24, also incorporated herein by reference. Preferred diisocyanates include 4,4′-diisocyanatodiphenylmethane, 2,4′-diisocyanatodiphenylmethane, isophorone diisocyanate, p-phenylene diisocyanate, 2,6-toluene diisocyanate, polyphenyl polymethylene polyisocyanate, 1,3-bis(isocyanatomethyl)cyclohexane, 1,4-diisocyanatocyclohexane, hexamethylene diisocyanate, 1,5-naphthalene diisocyanate, 3,3′-dimethyl-4,4′-biphenyl diisocyanate, 4,4′-diisocyanatodicyclohexylmethane, 2,4′-diisocyanatodicyclohexylmethane, and 2,4-toluene diisocyanate, or combinations thereof. More preferred diisocyanates are 4,4′-diisocyanatodicyclohexylmethane, 4,4′-diisocyanatodiphenylmethane, 2,4′-diisocyanatodi-cyclohexylmethane, and 2,4′-diisocyanatodiphenylmethane. Most preferred is 4,4′-diisocyanatodiphenylmethane and 2,4′-diisocyanatodiphenylmethane.

As used herein, the term “active hydrogen group” refers to a group that reacts with an isocyanate group to form a urea group, a thiourea group, or a urethane group as illustrated by the general reaction:

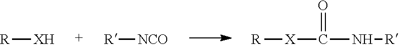

where X is O, S, NH, or N, and R and R′ are connecting groups which may be aliphatic, aromatic, or cycloaliphatic, or combinations thereof. The high molecular weight organic compound with at least two active hydrogen atoms typically has a molecular weight of not less than 500 Daltons.

The high molecular weight organic compound having at least two active hydrogen atoms may be a polyol, a polyamine, a polythiol, or a compound containing combinations of amines, thiols, and ethers. Depending on the properties desired, the polyol, polyamine, or polythiol compound may be primarily a diol, triol or polyol having greater active hydrogen functionality or a mixture thereof. It is also understood that these mixtures may have an overall active hydrogen functionality that is slightly below 2, for example, due to a small amount of monol in a polyol mixture.

As an illustration, it is preferred to use a high molecular weight compound or mixtures of compounds having an active hydrogen functionality of about 2 for an impregnating polyurethane dispersion whereas a higher functionality is typically more desirable for a polyurethane dispersion used to make a poromeric layer. The high molecular weight organic compound having at least two active hydrogen atoms may be a polyol (e.g, diol), a polyamine (e.g., diamine), a polythiol (e.g., dithiol) or mixtures of these (e.g., an alcohol-amine, a thiol-amine, or an alcohol-thiol). Typically the compound has a weight average molecular weight of at least about 500.

Preferably, the high molecular weight organic compound having at least two active hydrogen atoms is a polyalkylene glycol ether or thioether or polyester polyol or polythiol having the general formula:

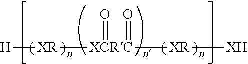

where each R is independently an alkylene radical; R′ is an alkylene or an arylene radical; each X is independently S or O, preferably O; n is a positive integer; and n′ is a non-negative integer.

Generally, the high molecular weight organic compound having at least two active hydrogen atoms has a weight average molecular weight of at least about 500 Daltons, preferably at least about 750 Daltons, and more preferably at least about 1000 Daltons. Preferably, the weight average molecular weight is at most about 20,000 Daltons, more preferably at most about 10,000 Daltons, more preferably at most about 5000 Daltons, and most preferably at most about 3000 Daltons.

Polyalkylene ether glycols and polyester polyols are preferred, for example, for making a polyurethane dispersion for impregnating the textile. Representative examples of polyalkylene ether glycols are polyethylene ether glycols, poly-1,2-propylene ether glycols, polytetramethylene ether glycols, poly-1,2-dimethylethylene ether glycols, poly-1,2-butylene ether glycol, and polydecamethylene ether glycols. Preferred polyester polyols include polybutylene adipate, caprolactone based polyester polyol and polyethylene terephthalate.

Preferably, the NCO:XH ratio, where X is O or S, preferably O, is not less than 1.1:1, more preferably not less than 1.2:1, and preferably not greater than 5:1.

The polyurethane prepolymer may be prepared by a batch or a continuous process. Useful methods include methods such as those known in the art. For example, a stoichiometric excess of a diisocyanate and a polyol can be introduced in separate streams into a static or an active mixer at a temperature suitable for controlled reaction of the reagents, typically from about 40° C. to about 100° C. A catalyst may be used to facilitate the reaction of the reagents such as an organotin catalyst (e.g., stannous octoate). The reaction is generally carried to substantial completion in a mixing tank to form the prepolymer.

The external stabilizing surfactant may be (b) at least one anionic surfactant or (c) at least one cationic surfactant as described hereafter in the present disclosure.

The polyurethane dispersion may be prepared by any suitable method such as those well known in the art. (See, for example, U.S. Pat. No. 5,539,021, column 1, lines 9 to 45, which teachings are incorporated herein by reference.)

When making the polyurethane dispersion, the prepolymer may be extended by water solely, or may be extended using a chain extender such as those known in the art. When used, the chain extender may be any isocyanate reactive diamine or amine having another isocyanate reactive group and a molecular weight of from about 60 to about 450, but is preferably selected from the group consisting of: an aminated polyether diol; piperazine, aminoethylethanolamine, ethanolamine, ethylenediamine and mixtures thereof. Preferably, the amine chain extender is dissolved in the water used to make the dispersion.

In a preferred method of preparing the nonionizable polyurethane dispersion, a flowing stream containing the prepolymer is merged with a flowing stream containing water with sufficient shear to form the polyurethane dispersion. Optionally and preferably, an amount of a stabilizing surfactant is also present, either in the stream containing the prepolymer, in the stream containing the water, or in a separate stream. The relative rates of the stream containing the prepolymer (R2) and the stream containing the water (R1) are preferably such that the polydispersity of the HIPR emulsion (the ratio of the volume average diameter and the number average diameter of the particles or droplets, or Dv/Dn) is not greater than about 5, more preferably not greater than about 3, more preferably not greater than about 2, more preferably not greater than about 1.5, and most preferably not greater than about 1.3; or the volume average particle size is not greater than about 2 microns, more preferably not greater than about 1 micron, more preferably not greater than about 0.5 micron, and most preferably not greater than about 0.3 micron. Furthermore, it is preferred that the aqueous polyurethane dispersion be prepared in a continuous process without phase inversion or stepwise distribution of an internal phase into an external phase.

The external surfactant is sometimes used as a concentrate in water. In this case, if it is used during the preparation of the aqueous polyurethane dispersion, a stream containing the surfactant is advantageously first merged with a stream containing the prepolymer to form a prepolymer/surfactant mixture. Although the polyurethane dispersion can be prepared in this single step, it is preferred that a stream containing the prepolymer and the surfactant be merged with a water stream to dilute the surfactant and to create the aqueous polyurethane dispersion.

The aqueous polyurethane dispersion (a) may have any suitable solids loading of polyurethane particles, but the solids loading is generally between about 1% to about 70% solids by weight of the total dispersion weight, preferably at least about 2%, more preferably at least about 4%, more preferably at least about 6%, more preferably at least about 15%, more preferably at least about 25%, more preferably at least about 35%, most preferably at least about 40%, to at most about 70%, preferably at most 68%, more preferably at most about 65%, more preferably at most about 60%, more preferably at most about 55% and most preferably at most about 50% by weight.

The aqueous polyurethane dispersion may also contain a rheological modifier such as thickeners that enhance the dispersability and stability of the dispersion. Any suitable rheological modifier may be used such as those known in the art. Preferably, the rheological modifier is one that does not cause the dispersion to become unstable. More preferably, the rheological modifier is a water soluble thickener that is not ionized. Examples of useful rheological modifiers include methyl cellulose ethers, alkali swellable thickeners (e.g., sodium or ammonium neutralized acrylic acid polymers), hydrophobically modified alkali swellable thickeners (e.g., hydrophobically modified acrylic acid copolymers) and associative thickeners (e.g., hydrophobically modified ethylene-oxide-based urethane block copolymers). Preferably the rheological modifier is a methylcellulose ether. The amount of thickener is from at least about 0.2% to about 5% by weight of the total weight of the aqueous polyurethane dispersion, preferably from about 0.5% to about 2% by weight.

According to one embodiment of the present disclosure, the aqueous polyurethane dispersion may further comprise other additives including but not limited to deformers, fillers, UV stabilizerss, crosslinkers, pigments, dyes, colorants, and so on, as long as these additives will not influence the stability of PUD.

Generally, the aqueous polyurethane dispersion has a viscosity from at least about 10 cp to at most about 10,000 cp, preferably, from at least about 20 cp to at most about 5000 cp, more preferably, from at least about 30 cp to at most about 3000 cp.

The aqueous polyurethane dispersion may also comprise other polymer dispersions such as acrylic latex, polyolefin latex and so on. Polyurethane accounts for greater than 30% volume fraction of the dried film if other polymer dispersions exist in the slurry.

A Cationic Surfactant

The cationic surfactant has a general structure as shown below, in which R¹ is a C10-18 alkyl group, R², R³, and R⁴ are C₁-C₆ alkyl group, preferably C₁-C₃ alkyl group, X is halide, preferably, chloride or bromide. The examples of cationic surfactants include but are not limited to dodecyl-trimethylammonium bromide (DTAB), and cetyl-trimethylammonium bromide (CTAB)).

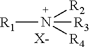

An Anionic Surfactant

Anionic surfactants are anionic sulfate or sulfonate surfactants, preferably selected from the group consisting of alkyl sulfate, alkyl sulfonate, alkylbenzene sulfate, alkylbenzene sulfonate, alkyl alcohol alkoxylate sulfate and alkyl alcohol alkoxylate sulfonate, preferably, in which alkyl group is C8-C18 alkyl, and the alkoxylate is C2-C3 alkyloxyl.

The examples of Anionic surfactants include but are not limited to sodium dodecyl benzene sulfonate, DOWFAX AS-801 surfactant (available from The Dow Chemical Company, sodium C8 alkyl alcohol ethoxylated propoxylated sulfate, DOWFAX is a trademark of The Dow Chemical Company) or sodium C12 alkyl alcohol ethoxylated sulfate.

A Heat-Sensitive Aqueous Polyurethane Dispersion

For the preparation of the heat-sensitive aqueous polyurethane dispersion comprising: (a) an aqueous polyurethane dispersion; (b) at least one anionic surfactant; and (c) at least one cationic surfactant, one of the component (b) at least one anionic surfactant and (c) at least one cationic surfactant can be added into the component (a) an aqueous polyurethane dispersion during the preparation process of the component (a) an aqueous polyurethane dispersion or added into the component (a) an aqueous polyurethane dispersion after its preparation. Then, the other one of the component (b) at least one anionic surfactant and the component (c) at least one cationic surfactant is added.

Therefore, the method for preparing the heat sensitive aqueous polyurethane dispersion of the present disclosure comprises (i) providing (a) an aqueous polyurethane dispersion; (b) at least one anionic surfactant and (c) at least one cationic surfactant; and (ii) mixing them together, or

the method for preparing a heat-sensitive aqueous polyurethane dispersion of the present disclosure comprises (i) providing (a) an aqueous polyurethane dispersion externally emulsified by (b) at least one anionic surfactant, (ii) providing (c) at least one cationic surfactant; and (iii) mixing them together; or

the method for preparing a heat-sensitive aqueous polyurethane dispersion of the present disclosure, comprises (i) providing (a) an aqueous polyurethane dispersion externally emulsified by (c) at least one cationic surfactant, (ii) providing (b) at least one anionic surfactant; and (iii) mixing them together.

No matter when the component (b) at least one anionic surfactant or the component (c) at least one cationic surfactant is added, the weight ratio of (b) at least one anionic surfactant to (c) at least one cationic surfactant is 10:1 to 1:5, preferably from 6:1 to 1:3, and more preferably from 3:1 to 1:1.

The weight ratio of (b) at least one anionic surfactant to the solid of (a) an aqueous polyurethane dispersion is 0.1% to 20%, preferably 0.3% to 15%, more preferably 0.5% to 10%, even more preferably 0.8% to 8%, still more preferably 1% to 3%.

The weight ratio of (c) at least one cationic surfactant to the solid of (a) an aqueous polyurethane dispersion is 0.1% to 20%, preferably 0.3% to 15%, more preferably 0.5% to 10%, even more preferably 0.8% to 8%, still more preferably 1% to 3%.

Accordingly, the present disclosure also discloses a method to transform non-heat-sensitive PUD to a heat sensitive PUD by adding (b) at least one anionic surfactant and (c) at least one cationic surfactant to (a) an aqueous polyurethane dispersion; or

adding (c) at least one cationic surfactant to (a) an aqueous polyurethane dispersion externally emulsified by (b) at least one anionic surfactant; or

adding (b) at least one anionic surfactant to (a) an aqueous polyurethane dispersion externally emulsified by (c) at least one cationic surfactant.

wherein (a) an aqueous polyurethane dispersion, (b) at least one anionic surfactant and (c) at least one cationic surfactant are described as above.

When both anionic and cationic surfactants are used at the same time, the PUD will become thermally gellable/coagulable at certain surfactant ratios and solid contents once heated.

A Synthetic Leather Article

The synthetic leather article comprising a film derived from the heat-sensitive aqueous polyurethane dispersion as described in the present disclosure. The synthetic leather article can be made by the conventional method in the art.

A Coating

The present disclosure also relates to a coating comprising the heat-sensitive aqueous polyurethane dispersion, which is stable at room temperature and become thermally gellable/coagulable under high temperature such 40-130° C., preferably 50-100° C.

The coatings can be a fast drying coating or a cellular coating.

### Examples

Some embodiments of the invention will now be described in the following Examples, wherein all parts and percentages are by weight unless otherwise specified.

The information of the raw materials used in the examples is listed in the following Table 1:

TABLE 1
Raw Materials used in this invention

| Components | Grades | Abbr. | Supplier |
|---|---|---|---|
| Externally emulsified polyurethane | | PUD-1 | Prepared in |
| dispersion with anionic sulfonate | | | the synthetic |
| surfactant (sodium dodecyl benzene | | | example a |
| sulfonate), solid content = 54% | | | |
| Externally emulsified polyurethane | | PUD-2 | Prepared in |
| dispersion with anionic sulfonate | | | the synthetic |
| surfactant (DOWFAX AS-801, Dow | | | example b |
| Chemical), solid content = 40% | | | |
| Internally emulsified polyurethane | Dispercoll U54 | U54 | Covestro |
| dispersion, solid content = 50% | | | |
| Internally emulsified polyurethane | Impranil DL 1380 | DL1380 | Covestro |
| dispersion, solid content = 58% | | | |
| Internally emulsified polyurethane | 51UD | 51UD | Dow Chemical |
| dispersion, solid content = 35% | | | |
| Internally emulsified polyurethane | 91UD | 91UD | Dow Chemical |
| dispersion, solid content = 38% | | | |
| Internally emulsified polyurethane | Caprol 8042 | Caprol 8042 | Kaparuei Chemical |
| dispersion, solid content = 40% | | | Co. Ltd |
| Hexadecyl trimethyl ammonium bromide | 99% purity | CTAB | SCRC |
| (57-09-0) or cetyl trimethyl ammonium | | | |
| bromide | | | |
| Dodecyl trimethyl ammonium bromide | 99% purity | DTAB | SCRC |
| (1119-94-4) | | | |
| sodium dodecyl benzene sulfonate | | | Solvay |
| (25155-30-0), solid content 23% | | | |
| DOWFAX AS-801 | | | Dow Chemical |

### Synthetic Examples of Polyurethane Dispersions

a. The Synthesis of Externally Emulsified Polyurethane Dispersion PUD-1 with Anionic Sulfonate Surfactant (Sodium Dodecyl Benzene Sulfonate, Solid Content 23%), Solid Content=54%

Prepolymer synthesis: 68 g Voranol 9287A (available from Dow Chemical) and 2 g MPEG 1000 (available from Dow Chemical) were charged into a three-neck flask under mechanical stirring, and dehydrated at 110° C. for one hour, then cooled down to 70-75° C. 30 g MMDI (monomeric 4,4′-Diphenyl-methane-diisocyanate, available from Dow Chemical) was added into the dehydrated blend polyols. The flask temperature was kept at 70-75° C. for 1 hr, and then raised to 80-85° C., kept for 2-3 hours to complete the reaction. The prepolymer was cooled down, packaged with plastic bottle and stored hermetically under nitrogen protection. NCO content in the prepolymer was 7.1 wt %.

PUD-1 synthesis: 90 g so-synthesized prepolymer was charged to a 1000 ml plastic cup (I.D. about 9 cm) equipped with Cowels Blade with O.D. about 7 cm. The rotation speed was set at 4000 rpm. 11.7 g 23% sodium dodecyl benzene sulfonate solution in water was added into the prepolymer, mixed for 30 sec, and then 80.5 g ice water (ice to water=1:1 by weight) was added in 5 sec. After mixing for 5 min, 18 g 10% AEEA (aminoethylethanolamine, available from Dow Chemical) solution in water was added, and kept for additional 3 min mixing to get the final PUD-1 with a solid content of 54%.

b. The Synthesis of Externally Emulsified Polyurethane Dispersion PUD-2 with Anionic Sulfonate Surfactant (DOWFAX AS-801, Dow Chemical), Solid Content=40%

Prepolymer synthesis: 68 g Voranol 9287A (available from Dow Chemical) and 2 g MPEG 1000 (available from Dow Chemical) were charged into a three-neck flask under mechanical stirring, and dehydrated at 110° C. for one hour, then cooled down to 70-75° C. 30 g MMDI (monomeric 4,4′-Diphenyl-methane-diisocyanate, available from Dow Chemical) was added into the dehydrated blend polyols. The flask temperature was kept at 70-75° C. for 1 hr, and then raised to 80-85° C., kept for 2-3 hours to complete the reaction. The prepolymer was cooled down, packaged with plastic bottle and stored hermetically under nitrogen protection. NCO content in the prepolymer was 7.1 wt %.

PUD-2 synthesis: 90 g so-synthesized prepolymer was charged to a 1000 ml plastic cup (I.D. about 9 cm) equipped with Cowels Blade with O.D. about 7 cm. The rotation speed was set at 4000 rpm. 11.7 g 20% AS-801 solution in water was added into the prepolymer, mixed for 30 sec, and then 117 g ice water (ice to water=1:1 by weight) was added in 5 sec. After mixing for 5 min, 18 g 10% AEEA (aminoethylethanolamine, available from Dow Chemical) solution in water was added, and kept for additional 3 min mixing to get the final PUD-2 with a solid content of 40%.

### Control Examples

Control examples No. 1 to No. 6 are listed in Table 2. Three types of control examples are performed. The sample of Control Example No. 1 only used PUD-1 without any additives, which was always stable at RT and after high temperature treatment. The samples of Control Example No. 2 to No. 5 used four types of internally emulsified PUDs, and all of them were found to coagulate immediately once contacting with DTAB at room temperature, not mention the high temperature. The sample of Control Example No. 6 used PUD Caprol 8042 and additive CTAB. The dispersion was stable both under room temperature and high temperature treatment.

### Inventive Examples

Inventive examples No. 7-17 are listed in Table 2. From No. 7 to No. 15, the solid content of PUD-1 is adjusted from 54% to 15% by adding deionized water. The additive, DTAB, was added in the form of 20% active aqueous solution. PUD and additive solution were mixed by a mechanical stirrer @1000 RPM for 5 min. Inventive Example No. 10 had a slight viscosity increase after 1 hour, and became very viscous after 24 hours. Other examples were still keeping the initial viscosity after 15 days under RT. In Inventive Example No. 16 DTAB was replaced with CTAB. In Inventive Example No. 17, the surfactant of PUD-1 was replaced with another anionic surfactant, DOWFAX AS-801 (Dow Chemical).

After 80° C. treatment in oven for 5 min (sealed in a container, no/very little water evaporates), some of the examples were well gelled to keep its original shape, while others weren't.

The additive such as DTAB and CTAB transforms the non-temperature-sensitive PUD to a thermally gelled PUD while keeping it stable at room temperature.

TABLE 2
Control Examples and Inventive Examples

| | | | | | | | Stability after | Treated |
|---|---|---|---|---|---|---|---|---|
| | | | | | | | mixing at room | under |
| | | | PUD solid | | Additive/ | Anionic/ | temperature | 80° C. |
| | No. | PUD type | content | Additive | PU solid | cationic ratio | (after 1 hour) | for 5 min |
| Control | 1 | PUD-1 | 54.0% | N/A | 0% | 0 | Stable | Stable |
| example | 2 | U54 | 50.0% | DTAB | 1.0% | unknown | Coagulated | N/A |
| | | | | | | | immediately | |
| | 3 | DL1380 | 58.0% | DTAB | 1.0% | unknown | Coagulated | N/A |
| | | | | | | | immediately | |
| | 4 | 51UD | 35.0% | DTAB | 1.0% | unknown | Coagulated | N/A |
| | | | | | | | immediately | |
| | 5 | 91UD | 38.0% | DTAB | 1.0% | unknown | Coagulated | N/A |
| | | | | | | | immediately | |
| | 6 | Caprol 8042 | 40.0% | CTAB | 4.0% | unknown | Stable | Stable |
| Inventive | 7 | PUD-1 | 54.0% | DTAB | 0.5% | 6:1 | Stable | Partially |
| example | | | | | | | | coagulated |
| | 8 | PUD-1 | 54.0% | DTAB | 1.0% | 3:1 | Stable | gelled |
| | 9 | PUD-1 | 54.0% | DTAB | 2.0% | 3:2 | Stable | gelled |
| | 10 | PUD-1 | 54.0% | DTAB | 3.0% | 1:1 | Stable, viscosity | gelled |
| | | | | | | | slightly increased | |
| | 11 | PUD-1 | 45.0% | DTAB | 1.0% | 3:1 | Stable | gelled |
| | 12 | PUD-1 | 35.0% | DTAB | 2.0% | 3:2 | Stable | gelled |
| | 13 | PUD-1 | 35.0% | DTAB | 1.0% | 3:1 | Stable | Partially |
| | | | | | | | | coagulated |
| | 14 | PUD-1 | 54.0% | DTAB | 9.0% | 1:3 | Stable | Not fully |
| | | | | | | | | gelled |
| | 15 | PUD-1 | 15.0% | DTAB | 3.0% | 1:1 | Stable | gelled |
| | 16 | PUD-1 | 25.0% | CTAB | 3.0% | 1:1 | Stable | gelled |
| | 17 | PUD-2 | 40.0% | DTAB | 3.0% | 1:1 | Stable | gelled |

As can be seen from FIG. 1, in Control Example 2, 3, 4 and 5, after the PUDs were mixed with DTAB at room temperature, the dispersions were coagulated immediately.

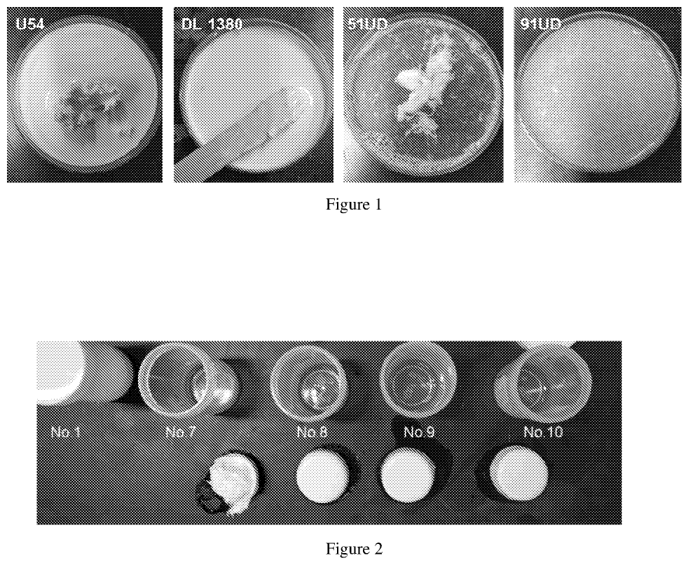

As can be seen from FIG. 2, in Inventive Example 8, 9 and 10, after the PUDs were mixed with DTAB and treated under 80° C. for 5 minutes, the dispersions were fully gelled. In Control Example 1, after the PUD without DTAB was treated under 80° C. for 5 minutes, the dispersion was stable as its initial state. In Inventive Example 7, after the PUD was mixed with DTAB and treated under 80° C. for 5 minutes, the dispersion was partially coagulated.

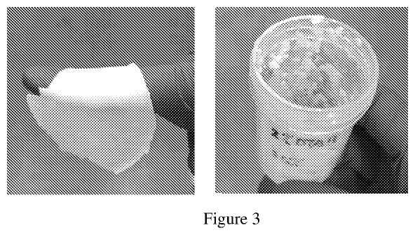

As can be seen from FIG. 3, in Inventive Example 8, after the PUD was mixed with DTAB and treated under 80° C. for 5 minutes, the dispersion was fully gelled. In Inventive Example 13, after the PUD was mixed with DTAB and treated under 80° C. for 5 minutes, the dispersion was partially coagulated.

In Inventive Examples 7-17, no matter the dispersions were fully gelled or partially coagulated once they were mixed with DTAB or CTAB under 80° C. for 5 minutes, the dispersions were transformed from non-temperature-sensitive PUDs to a thermally gelled PUD while keeping stable at room temperature.

1. A heat sensitive aqueous polyurethane dispersion comprising:
(a) an aqueous polyurethane dispersion;
(b) at least one anionic surfactant; and
(c) at least one cationic surfactant.

2. The heat sensitive aqueous polyurethane dispersion according to claim 1, wherein the anionic surfactant is selected from the group consisting of alkyl sulfate, alkyl sulfonate, alkylbenzene sulfate, alkylbenzene sulfate sulfonate, alkyl alcohol alkoxylate sulfate and alkyl alcohol alkoxylate sulfonate.

3. The heat sensitive aqueous polyurethane dispersion according to claim 2, wherein the alkyl group is C8-C18 alkyl, and the alkoxylate is C2-C3 alkyloxyl.

4. The heat sensitive aqueous polyurethane dispersion according to claim 1, wherein the anionic surfactant is selected from the group consisting of sodium dodecyl benzene sulfonate, sodium C8 alkyl alcohol ethoxylated propoxylated sulfate and sodium C12 alkyl alcohol ethoxylated sulfate.

5. The heat sensitive aqueous polyurethane dispersion according to claim 1, wherein the cationic surfactant has a general structure as shown below, in which R¹ is a C10-18 alkyl group, R², R³, and R⁴ are C₁-C₆ alkyl group, and X is halide

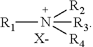

6. The heat sensitive aqueous polyurethane dispersion according to claim 1, wherein the cationic surfactant is dodecyl-trimethylammonium bromide, cetyl-trimethylammonium bromide or a mixture thereof.

7. The heat sensitive aqueous polyurethane dispersion according to claim 1, wherein the solids loading of the polyurethane dispersion is between about 1% to about 70% solids by weight of the total dispersion weight.

8. The heat sensitive aqueous polyurethane dispersion according to claim 1, wherein the weight ratio of (b) at least one anionic surfactant to (c) at least one cationic surfactant is 10:1 to 1:5.

9. The heat sensitive aqueous polyurethane dispersion according to claim 1, wherein the polyurethane dispersion comprises a nonionizable polyurethane.

10. The heat sensitive aqueous polyurethane dispersion according to claim 8, wherein the nonionizable polyurethane is prepared by reacting a polyurethane/urea/thiourea prepolymer with a chain-extending reagent in an aqueous medium.

11. The heat sensitive aqueous polyurethane dispersion according to claim 1, wherein (a) the aqueous polyurethane dispersion is externally emulsified with (b) at least one anionic surfactant or (c) at least one cationic surfactant.

12. The heat sensitive aqueous polyurethane dispersion according to claim 1, wherein the weight ratio of (c) at least one cationic surfactant to the solid of (a) an aqueous polyurethane dispersion is 0.1% to 20%.

13. A method for preparing the heat sensitive aqueous polyurethane dispersion according to claim 1, the method comprising (i) providing (a) an aqueous polyurethane dispersion; (b) at least one anionic surfactant and (c) at least one cationic surfactant; and (ii) mixing them together, or
comprising (i) providing (a) an aqueous polyurethane dispersion externally emulsified by (b) at least one n anionic surfactant, (ii) providing (c) at least one cationic surfactant; and (iii) mixing them together; or
comprising (i) providing (a) an aqueous polyurethane dispersion externally emulsified by (c) at least one cationic surfactant, (ii) providing (b) at least one anionic surfactant; and (iii) mixing them together.

14. A synthetic leather article, comprising a film derived from the heat-sensitive aqueous polyurethane dispersion according to claim 1.

15. A coating comprising the heat-sensitive aqueous polyurethane dispersion according to claim 1.
